(19) United States
(12) Patent Application Publication
(10) Pub. No.: US 2014/0187450 A1
(43) Pub. Date: Jul. 3, 2014

(54) Internal Breaker for Fluid Loss Control Pills and Method

(71) Applicant: Superior Energy Services, L.L.C., Harvey, LA (US)

(72) Inventor: Sumitra Mukhopadhyay, The Woodlands, TX (US)

(73) Assignee: Superior Energy Services, L.L.C., Harvey, LA (US)

(21) Appl. No.: 13/729,122

(22) Filed: Dec. 28, 2012

(51) Int. Cl. C09K 8/84

(52) U.S. Cl. CPC C09K 8/845
USPC 507/140; 507/269; 507/274; 507/203; 507/213; 507/214; 507/270; 507/266; 507/201; 507/211; 507/273

(57) ABSTRACT

A method of treating a subterranean formation. The method may include providing a fluid-loss control pill that comprises an aqueous base fluid, a gelling agent, and an internal breaker that is selected from the group consisting of inorganic delayed acids or inorganic salts. The method can include introducing the fluid-loss control pill into a subterranean formation, allowing the internal breaker to reduce the viscosity of the pill after a delay period, and allowing the fluid-loss control pill to break.

### BACKGROUND OF THE INVENTION

The present disclosure relates to methods and compositions for treating subterranean formations, and more specifically to internal breakers for fluid loss control pills. The fluid loss control pills of the present disclosure comprise an aqueous base fluid, a gelling agent, and an internal breaker.

Fluid loss control pills consisting of highly viscous polymers are used during well simulations and completions to stop seepage or steady brine loss to the formation. Fluid loss occurs when the hydrostatic pressure head on the fluid is greater than the formation pressure. One of the reasons fluid loss control is necessary is to prevent losses of expensive high density brines. Also, fluid loss can disrupt the well pressure control because of high gas influx into the wellbore and can cause an unsafe condition. Furthermore, uncontrolled brine infiltration to the formation can create a chemical imbalance, which may lead to formation damage. The most common method of fluid loss control is to pump a viscous pill into the thief zone. However, clean-up of these pills is extremely necessary after the completion work as these can be quite damaging to the formation and difficult to be removed from the perforation tunnel. Both internal and external breakers for the pills are used. However, the internal breakers, generally oxidizers, are rapid in action and cannot provide controlled breaking over time. A strong acid, namely 10 to 15% hydrochloric acid, is employed as the most common external breaker in the prior art. However, this strong acid can cause a corrosive and unsafe environment.

### SUMMARY OF THE INVENTION

A method of treating a subterranean formation is disclosed. In one embodiment, the method includes providing a fluid-loss control pill that comprises an aqueous base fluid, a gelling agent, and an internal breaker that is selected from the group consisting of inorganic delayed acids and inorganic salts. The method further includes introducing the fluid-loss control pill into a subterranean formation, allowing the internal breaker to reduce the viscosity of the pill after a delay period, and allowing the fluid-loss control pill to break. In one embodiment, the inorganic salts include alkali metal salts selected from a group consisting of bisulfite and bisulfate ions. In another embodiment, the inorganic delay acids are selected from the group consisting of sulfamic acid, sulfonic acid and its derivatives, toluensulfonic acid, phosphonic acid and its derivatives, and aluminum chloride and other Lewis acids. The inorganic salts and inorganic delayed acids may be encapsulated.

As per the teachings of the present disclosure, in one embodiment the gelling agent comprises at least one polymer selected from the group consisting of a natural polymer, a synthetic polymer, xanthan, a xanthan derivative, a guar, a guar derivative, cellulose, and a cellulose derivative. The gelling agent may comprise a crosslinked gelling agent that crosslinks the gelling agent in a crosslinking reaction. The crosslinked gelling agent may include at least one crosslinking agent comprising a polyvalent metal ion, such as aluminum, antimony, boron, chromium, zirconium or titanium (including organotitanates).

Additionally, the fluid-loss control pill may comprise an additive selected from the group consisting of propylene glycol, a gel stabilizer, a clay fixer, a bridging particulate, a surfactant, a corrosion inhibitor, a biocide, a pH control additive, an oxidizer, an enzyme, an encapsulated breaker, an inorganic acid, an organic acid, and a weighting agent.

In another embodiment, a method of treating a subterranean formation is disclosed that comprises providing a fluid-loss control pill that comprises an aqueous base fluid, a gelling agent, and an internal breaker that comprises inorganic salts that includes alkali metal salts. The fluid-loss control pill is introduced into a subterranean formation, and the internal breaker is allowed to generate an acid after a delay period, which in turn allows the fluid-loss control pill to break. In one embodiment, the alkali metal salts are selected from a group consisting of bisulfite and bisulfate ions. More specially, the alkali metal salts are selected from a group consisting of bisulfate, bisulfite, metabisulfate, metabisulfite salts, ammonium chloride (NH₄Cl), ammonium oxalate ((NH₄)₂C₂O₄H₂O), sodium bicarbonate (NaHCO₃), sodium hydrosulfide (NaHS), sodium bisulfate (NaHSO₄), monosodium phosphate (NaH₂PO₄), disodium phosphate (Na₂HPO₄), and also the potassium salts. Generally, the breaker generates the acid from between 2 hours to 7 days. The gelling agent may comprise at least one polymer selected from the group consisting of a natural polymer, a synthetic polymer, xanthan, a xanthan derivative, a guar, a guar derivative, cellulose, and a cellulose derivative. In this embodiment, the fluid-loss control pill may comprise an additive selected from the group including propylene glycol, a gel stabilizer, a clay fixer, a bridging particulate, a surfactant, a corrosion inhibitor, a biocide, a pH control additive, an oxidizer, an enzyme, an encapsulated breaker, an inorganic acid, an organic acid, and a weighting agent. The breaker may be a solid form, a solution form, or a slurry form, or may be encapsulated.

In one embodiment, the subterranean formation temperature is between 100 degrees F. and 400 degrees F. Generally, the fluid-loss control pill has a pH between 4 to 11. In one preferred embodiment, the step of introducing the fluid-loss control pill for a well treatment may be for a fracturing treatment, a gravel packing treatment or a loss circulation treatment.

### BRIEF DESCRIPTION OF THE DRAWING

FIG. 1 is a schematic of a rig with a well extending therefrom.

### DETAILED DESCRIPTION OF THE PREFERRED EMBODIMENTS

As noted earlier, the fluid loss control pill comprises a viscous fluid that will be gelled. Aqueous base fluids that are commonly used in oilfield operations usually include sodium chloride brines, potassium chloride brines, calcium chloride brines, zinc chloride brines, and zinc bromide brine.

Suitable gelling agents that may or may not be crosslinked, depending on the pH of the pill, or the pH of the environment in which the pill will be used, include but not limited to: xanthan, xanthan derivatives, guar, guar derivatives (such as hydroxypropyl guar, carboxymethyl guar, and carboxymethylhydroxyprpyl guar), cellulose and cellulose derivatives (such as hydroxyethyl cellulose (HEC), and carboxymethyethyl cellulose), succinoglycan, carboxymethyl HEC, double-derivatized' HEC (DDHEC), and polyols. In some embodiments, the gelling agent may be crosslinked; in others, the gelling agents may not be crosslinked. Preferably, the gelling agent is crosslinked before the pill is placed in the subterranean formation (e.g. before pumping or during pumping). The crosslinked gelling agent may include at least one crosslinking agent comprising a polyvalent metal ion. For instance, the crosslinking agent may contain a metal ion such as aluminum, antimony, boron, chromium, zirconium or titanium (including organotitanates).

The fluid loss control pill may be broken (i.e. its viscosity may be reduced) by lowering the pH of the fluid by addition of an internal breaker of the present invention. The internal breakers comprise solid or liquid inorganic acids, or inorganic salts, which will generate an acid down hole in a delayed fashion that will break the fluid loss control pills. The delay period may vary from a few hours to a several days.

Examples of suitable inorganic acids include sulfamic acid (H₃NSO₃), and sulfonic acid and its derivatives such as trifluoromethanesulfonic acid (also known as triflic acid (CF₃SO₃H)) and toluenesulfonic acid C₆H₄CH₃SO₃H, phosphonic acids and its derivatives (ROP(OH₂)) where R is an organic radical such as C6H5, as in phenylphosponic acid), aluminum chloride (AlCl₃) or other Lewis acids. Other examples of inorganic acids that can be used as breakers include hydrochloric acid, nitric acid, sulfuric acid, phosphoric acid, boric acid, and hydrofluoric acid. These inorganic acids can be encapsulated or emulsified to delay their activity

Examples of suitable inorganic salts for use in the delayed acid breakers of the present disclosure have a structure described by the formula: NaHSO₃ or Na₂S₂O₅. The internal breakers may comprise slow acid forming inorganic salts in water. The examples include but are not limited to alkali metal salts containing bisulfite and bisulfate ions. More specifically, examples of suitable inorganic salts include, but are not limited to bisulfate, bisulfite, metabisulfite, metabisulfate salts.

A feature of one embodiment of this disclosure is that the internal breakers are environmentally friendly and they can provide a controlled break from a few hours to over several days.

Generally speaking, the amount of the breaker to include is an amount sufficient to neutralize any inhibitor that may have been placed in the fluid loss control pill and reduce the pH of the fluid loss control pill to a level sufficient to break it. This amount will be determinable by one of ordinary skill in the art with the benefit of this disclosure. In some embodiments, this may be from about 5 lb./1000 gal. to about 30 lb./1000 gal. based on the volume of the fluid loss control pill.

The inorganic salts and inorganic acids used in the internal acid breakers of the present invention can have any suitable form. For instance, these compositions can be used in a solution form, an encapsulated form, a solid form, liquid form, solution, slurry or an emulsion form. For the solution form, suitable exemplary solvents include propylene glycol, propylene glycolmonomethyl ether, dipropyline glycol monomethyl ether, and ethylene glycol monobutyl ether. When in solid form, the materials may be crystalline or granular in nature. The solid forms may be encapsulated or provided with a coating to delay their release into the fluid. Encapsulating materials and methods of encapsulating are well known in the art.

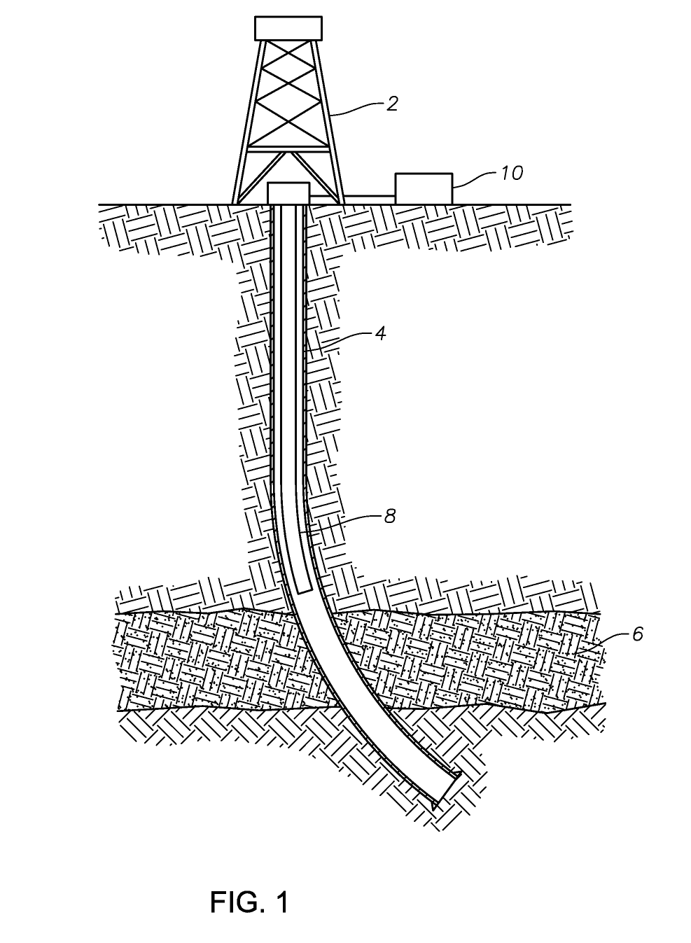

Referring now to FIG. 1, a schematic of a representative rig 2 with a well 4 extending therefrom is illustrated. In the FIG. 1, the well contains a casing string 4 intersecting a subterranean reservoir 6, which will now be described. The casing string 4 may contain perforations for communicating the reservoir 6 with the internal portion of the casing string 4 for communication of hydrocarbons to the surface as is readily understood by those of ordinary skill in the art. FIG. 1 depicts a concentrically placed string 8, wherein the string may be a production string, a work string (such as drill pipe), or a coiled tubing string. The internal breakers can be used in drilling, fracturing, gravel packing and other applications where a fluid loss control pill is used. As understood by those of ordinary skill in the art, the rig 2 will contain pump and mixing means 10. Hence, the pill herein disclosed can be mixed at the surface and pumped into the well 8 to a desired location for the treatment disclosed herein.

The following are possible additives that may be added to the solution containing the internal breaker: time delay inhibitors, oxidizers, enzymes, organic acids, inorganic acids, corrosion inhibitors and emulsifiers. See U.S. Pat. No. 7,347,265, assigned to BJ Services Company, columns three through seven, which is incorporated herein by reference. As understood by those of ordinary skill in the art, different well conditions (e.g. temperature, pressure, corrosive environment, etc.) dictate the specific types of additives that will be used.

The internal acid breakers of the present invention are generally stable at a pH of about 8 or above. To maintain the delay, preferably the pH should be maintained at 8 or above. To maintain this pH, the internal acid breakers or the pill may comprise an inhibitor. The inhibitor may further delay the generation of the acid from the inorganic salt compositions, and may also neutralize the generated acid during the delay period. Suitable inhibitors include bases and/or buffers. Examples of some preferred inhibitors may include sodium hydroxide, potassium hydroxide, magnesium oxide, or potassium carbonate buffer

Adding the internal acid breaker by way of an emulsion may be useful. Simultaneous addition of the internal acid of the present disclosure and a crosslinking agent is one embodiment of use because it allows the breaker to be distributed evenly within the base gel. Sometimes, it may be difficult to mix the breaker into an already crosslinked pill. In one preferred embodiment, the pill is generally delivered by ‘diluting’ it with brine so that pumping friction pressure is not too high. Hence, the internal breaker can be mixed with this brine solution with gentle shear so that mixing and dispersion may not be an issue.

In the emulsion embodiments, (e.g. where the fluid loss control pill base gel has a low pH), the emulsion of the internal acid breaker may be formed with water, a suitable emulsifying surfactant, optionally an inhibitor (e.g. wherein it is desirable to protect the inorganic salts from degradation during addition to a low pH base gel or when a longer delay time is desired), and optionally a crosslinking agent. Another advantage of placing the breaker in an emulsion is that the breaker is mixed in the pill in a relatively even fashion.

Suitable emulsifying surfactants for use in emulsification embodiments of this invention include any surfactant which is capable of making an oil in water emulsion, and which does not adversely affect a component of the pill or the breaker. Suitable emulsifying surfactants for use in the emulsification embodiments of this discloser include any surfactant which is capable of making an oil in water emulsion, and which does not adversely affect a component of the pill or the breaker.

Although the present invention has been described in considerable detail with reference to certain preferred versions thereof, other versions are possible. Therefore, the spirit and scope of the appended claims should not be limited to the description of the preferred versions contained herein.

I claim:

1. A method of treating a subterranean formation comprising:
providing a fluid-loss control pill that comprises an aqueous base fluid, a gelling agent, and an internal breaker that is selected from the group consisting of inorganic delayed acids and inorganic salts;
introducing the fluid-loss control pill into a subterranean formation;
allowing the internal breaker to reduce the viscosity of the pill after a delay period;
allowing the fluid-loss control pill to break.

2. The method of claim 1 wherein the inorganic salts consist of alkali metal salts that are selected from a group consisting of bisulfite and bisulfate ions.

3. The method of claim 1 wherein the inorganic salts are encapsulated.

4. The method of claim 1 wherein the inorganic delayed acids are encapsulated.

5. The method of claim 1 wherein the inorganic delay acids are selected from the group consisting of sulfamic acid, sulfonic acid and its derivatives, toluensulfonic acid, phosphonic acid and its derivatives, and aluminum chloride.

6. The method of claim 4 wherein the inorganic delay acids are selected from the group consisting of sulfamic acid, sulfonic acid and its derivatives, toluensulfonic acid, phosphonic acid and its derivatives, and aluminum chloride.

7. The method of claim 1 wherein the gelling agent comprises at least one polymer selected from the group consisting of a natural polymer, a synthetic polymer, an xanthan, an xanthan derivative, a guar, a guar derivative, cellulose, and a cellulose derivative.

8. The method of claim 1 wherein the gelling agent comprises a crosslinked gelling agent that crosslinks the gelling agent in a crosslinking reaction.

9. The method of claim 8 wherein the crosslinked gelling agent comprises a polyvalent metal ion.

10. The method of claim 8 wherein the crosslinked gelling agent comprises at least one crosslinking agent selected from the group consisting of aluminum, antimony, boron, chromium, zirconium and titanium.

11. The method of claim 10 wherein the fluid-loss control pill comprises an additive selected from the group consisting of propylene glycol, a gel stabilizer, a clay fixer, a bridging particulate, a surfactant, a corrosion inhibitor, a biocide, a pH control additive, an oxidizer, an enzyme, an encapsulated breaker, an inorganic acid, an organic acid, and a weighting agent.

12. A method of treating a subterranean formation comprising:
providing a fluid-loss control pill that comprises an aqueous base fluid, a gelling agent, and an internal breaker that comprises inorganic salts that consist of alkali metal salts;
introducing the fluid-loss control pill into a subterranean formation;
allowing the internal breaker to generate an acid after a delay period;
allowing the fluid-loss control pill to break.

13. The method of claim 12 wherein the alkali metal salts are selected from a group consisting of bisulfite and bisulfate ions.

14. The method of claim 12 wherein the amount of the internal breaker is between 5 lb./1,000 gal. and 30 lb./1,000 gal. based on the volume of the fluid loss control pill.

15. The method of claim 12 wherein the gelling agent comprises at least one polymer selected from the group consisting of a natural polymer, a synthetic polymer, xanthan, a xanthan derivative, a guar, a guar derivative, cellulose, and a cellulose derivative.

16. The method of claim 12 wherein the alkali metal salts are selected from a group consisting of bisulfate, bisulfite, metabisulfate, metabisulfite salts. ammonium chloride ammonium oxalate, sodium bicarbonate (NaHCO₃), sodium hydrosulfide (NaHS), sodium bisulfate (NaHSO₄), monosodium phosphate (NaH₂PO₄), and disodium phosphate (Na₂HPO₄).

17. The method of claim 12 wherein the gelling agent comprises a crosslinked gelling agent that crosslinks the gelling agent in a crosslinking reaction.

18. The method of claim 17 wherein the crosslinked gelling agent comprises a polyvalent metal ion.

19. The method of claim 17 wherein the crosslinked gelling agent comprises at least one crosslinking agent selected from the group consisting of aluminum, antimony, boron, chromium, zirconium and titanium.

20. The method of claim 17 wherein the fluid-loss control pill comprises an additive selected from the group consisting of: propylene glycol, a gel stabilizer, a clay fixer, a bridging particulate, a surfactant, a corrosion inhibitor, a biocide, a pH control additive, an oxidizer, an enzyme, an encapsulated breaker, an inorganic acid, an organic acid, and a weighting agent.

21. The method of claim 17 wherein said breaker can be a solid form, a solution form, emulsified form or a slurry form.

22. The method of claim 17 wherein the subterranean formation temperature is between 100 degrees F. and 400 degrees F.

23. The method of claim 17 wherein said breaker generates an acid from said inorganic salt, said acid from between one day to seven days.

24. The method of claim 17 wherein said fluid-loss control pill has a pH between 4 to 11.

25. The method of claim 17 wherein the step of introducing the fluid-loss control pill for a well treatment is selected from a group consisting of a fracturing treatment, a gravel packing treatment and a loss circulation treatment.
